(19) United States
(12) Patent Application Publication
(10) Pub. No.: US 2009/0040327 A1
(43) Pub. Date: Feb. 12, 2009

(54) Image-Taking Device

(76) Inventors: Toshihiko Ono, Yokohama (JP); Hiroaki Tachibana, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/164,223

(22) Filed: Jun. 30, 2008

(30) Foreign Application Priority Data
Aug. 9, 2007 (JP) 2007-208563

(51) Int. Cl. H04N 5/235

(52) U.S. Cl. 348/222.1; 348/E05.034

(57) ABSTRACT

An object of the present invention is to provide an image-taking device capable of preventing “howling.”

When a television set 5 as an external device is connected to an external output terminal of a video camera 1, a controller 17 generates image information to be output via the external output terminal in accordance with the type of external output terminal and outputs the image information to the television set 5; when the operation mode set by a mode setting unit 16 is play-mode, the controller 17 generates sound information to be output via the external output terminal in accordance with the type of external output terminal and outputs the image information to the television 5; and when the operation mode is camera-mode or record-mode, the controller 17 stops the output of sound information performed via external output terminals.

### CROSS-REFERENCE TO RELATED APPLICATIONS

This application relates to and claims priority from Japanese Patent Application No. 2007-208563, filed on Aug. 9, 2007, the entire disclosure of which is incorporated herein by reference.

### BACKGROUND

1. Field of the Invention

The invention relates generally to an image-taking device, and is suitable for application in an image-taking device capable of outputting image information and sound information to an external device connected via an external output terminal.

2. Description of Related Art

Recently, a video camera, which is an image-taking device, is capable of performing not only output using conventional analog signals but also output by using digital signals, such as via HDMI (High-Definition Multimedia Interface) or optical output, and therefore is capable of outputting high quality sound via a 5.1 channel surround system or the like (for example, see JP2006-286034 A).

### SUMMARY

Meanwhile, a video camera provided with a sound input/output feature may be subject to the phenomenon called “howling.” The “howling” is a phenomenon in which, when, for example, a sound input from a microphone is output from a speaker at the same time of the sound input, the output sound re-enters to the microphone and is amplified and output from the speaker repeatedly, and as a result, intense noise is continuously generated.

A video camera is often used by connection to a television set, and when the operational mode of a video camera is switched to camera-mode or record-mode, the “howling” tends to occur because ambient sound collected via the microphone is output from the television set.

The current invention has been devised in consideration of the above-described points, and it is an object of the present invention to provide an image-taking device capable of preventing “howling.”

In order to solve the above-described problems, according to an aspect of the invention, an image-taking device capable of outputting image information and sound information generated by using an image taken by image-taking means and sound input by sound input means to an external device connected via an external output terminal comprises: a detecting means for detecting that the external device is connected via the external output terminal; a mode determining means for determining the operational mode of the image-taking device; and sound information output stopping means for stopping sound information output via the external output terminal when the detecting means detects connection to the external device and the mode determining means determines that the operational mode is a mode in which sound is input by the sound input means.

According to the present invention, when an image-taking device is connected to an external device via an external output terminal and the operational mode of the image-taking device is a mode in which a sound can be input by a sound input means, it is possible to stop the output of sound information via the external output terminal, so that “howling” can be prevented.

Other aspects and advantages of the invention will be apparent from the following description and the appended claims.

### BRIEF DESCRIPTION OF THE DRAWINGS

FIG. 1 is a block diagram showing the configuration of a video camera according to the embodiment.

FIG. 2 is a flowchart illustrating processing executed in a video camera.

### DETAILED DESCRIPTION OF PREFERRED EMBODIMENTS

An embodiment of the present invention will be described below with reference to the attached drawings. It should be understood that the present invention is not limited to this embodiment.

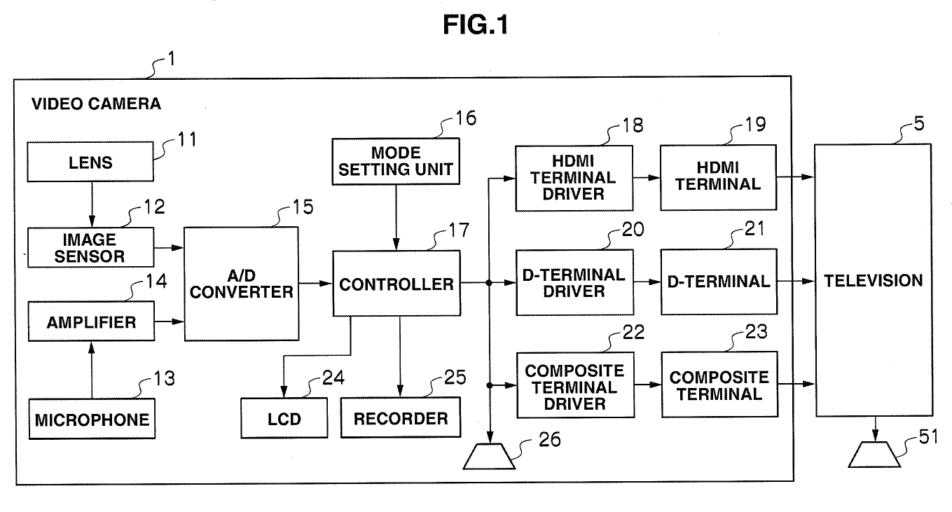

FIG. 1 shows a video camera according to the present embodiment. As shown in FIG. 1, a video camera 1 is provided with: a lens 11 and an image sensor 12 that are image-taking means; a microphone 13 and an amplifier 14 that are sound input means; an analog-to-digital (A/D) converter 15; a mode setting unit 16; a controller 17; an HDMI terminal driver 18; an HDMI terminal 19; a D-terminal driver 20; a D-terminal 21; a composite terminal driver 22; a composite terminal 23; an LCD 24 which is an image display means; a recorder 25; and a speaker 26 which is a sound output means. Thus, the video camera 1 according to the present embodiment has the HDMI terminal 19, the D-terminal 21, and the composite terminal 23 as external output terminals.

The image-taking means forms a subject image on the image sensor 12, such as CCD or CMOS, by lens 11, and generates image signals by the image sensor 12. The sound input means amplifies the sound collected by the microphone 13 with the amplifier 14 and generates sound signals.

The A/D converter 15 digitizes image signals generated by the image-taking means and sound signals generated by the sound input means, and converts those signals into image data and sound data.

The mode setting unit 16 sets the operational mode of the video camera 1 in accordance with the operating instructions from a user. The operational modes include, for example, camera-mode; record-mode; and

play-mode. The camera-mode is a mode in which an image currently taken by the image-taking means is displayed on the LCD 24, and sound currently collected by the sound input means is output from the speaker 26.

The record-mode is a mode in which an image taken by the image-taking means and sound collected by the sound input means are converted into image data and sound data respectively, and those pieces of data are recorded by the recorder 25.

The play-mode is a mode in which the image data recorded by the recorder 25 is converted into image signals for display and displayed on the LCD 24, and the sound data recorded by the recorder 25 is converted into sound signals and output from the speaker 26.

When the operational mode is camera-mode or record-mode, the sound input means switches to “ON” status, in which ambient sound is collected; and when the operational mode is play-mode, the sound input means switches to “OFF” status, in which ambient sound is not collected. In other words, the camera-mode and record-mode are the operational modes in which sound is input to the video camera by the sound input means; and the play-mode is the operational mode in which sound is not input to the video camera by the sound input means.

The controller 17 is a system control means including a microcomputer that performs overall control of the entire video camera 1, and the control of each component included in the video camera 1 and the overall control of the entire video camera 1 are performed by the controller 17. The feature of the controller 17 will be described below.

When detecting that a connection cable for connecting the video camera 1 and the television 5 is connected to the HDMI terminal 19, the controller 17 generates digital image data to be output from the HDMI terminal 19, and outputs this digital image data to the television 5 via the HDMI terminal driver 18 and HDMI terminal 19. As a result, an image corresponding to the image data is displayed on the display screen of the television 5.

When detecting that a connection cable for connecting the video camera 1 and the television 5 is connected to the D-terminal 21, the controller 17 generates analog image signals to be output from the D-terminal 21, and outputs these image signals to the television 5 via the D-terminal driver 20 and D-terminal 21. As a result, an image corresponding to the image signals is displayed on the display screen of the television 5.

When detecting that a connection cable for connecting the video camera 1 and the television 5 is connected to the composite terminal 23, the controller 17 generates image signals to be output from the composite terminal 23, and outputs these image signals to the television 5 via the composite terminal driver 22 and composite terminal 23. As a result, an image corresponding to the image signals is displayed on the display screen of the television 5.

When detecting that a connection cable for connecting the video camera 1 and the television 5 is connected to any one of the HDMI terminal 19, the D-terminal 21, and the composite terminal 23, the controller 17 determines whether or not the operational mode set by the mode setting unit 16 is play-mode.

If the controller 17 determines the operational mode set by the mode setting unit 16 is play-mode, the controller 17 outputs sound data recorded by the recorder 25 to the television 5. Specifically, when a connection cable is connected to the HDMI terminal 19, the controller 17 outputs sound data to the television 5 via the HDMI terminal driver 18 and HDMI terminal 19. Meanwhile, when a connection cable is connected to the D-terminal 21 or the composite terminal 23, the controller 17 converts sound data into sound signals for sound output, and outputs these sound signals to the television 5 via a sound output terminal (not shown), which is one of the external output terminals.

As a result, sound corresponding to sound data or sound signals (hereinafter referred to as “sound information”) is output from a speaker 51 of the television 5. However, when the operational mode is play-mode, no “howling” will occur since the sound input means is in “OFF” status.

If the controller 17 determines the operational mode set by the mode setting unit 16 is other than play-mode, the controller 17 stops outputting the sound information to the television 5.

As a result, when the operational mode is camera-mode or record-mode, in which the sound input means of the video camera 1 is in “ON” status, sound information is not output to the television 5. Consequently, sound corresponding to the sound information is not output from the speaker of the television 5, so “howling” can be prevented.

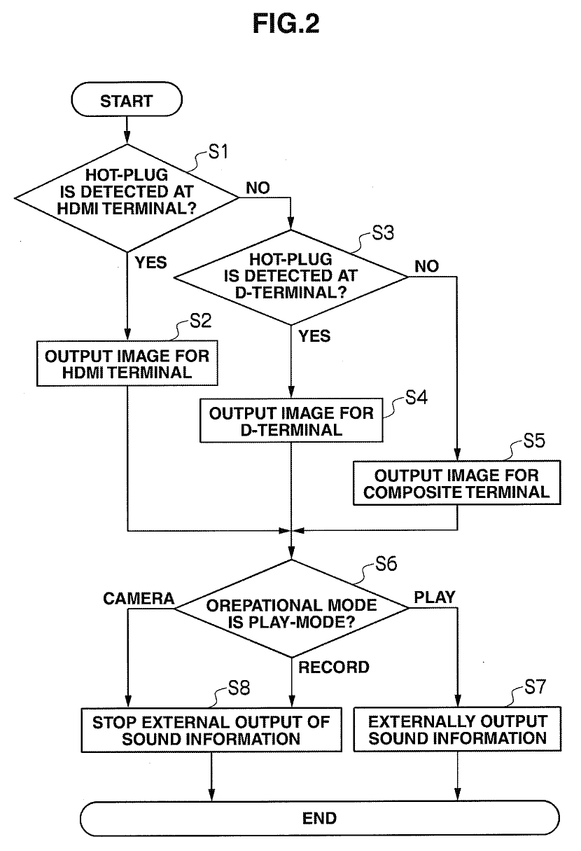

Next, steps in processing performed in the video camera 1 when the television 5 is connected as an external device to the external output terminals of the video camera 1 will be described with reference to FIG. 2. These processing steps will be described for the situation where any one of the HDMI terminal 19, the D-terminal 21, and the composite terminal 23 is hot-plugged after power is applied to the video camera 1. “Hot plug” is a feature where a device can recognize when an external device is connected to or disconnected from the device while it is running.

First, if the controller 17 detects that the HDMI terminal 19 is hot-plugged (step S1: YES), the controller 17 generates image data to be output from the HDMI terminal 19, and outputs the image data to the television 5 via the HDMI terminal driver 18 and HDMI terminal 19 (step S2).

On the other hand, if the controller 17 detects the HDMI terminal 19 is not hot-plugged (step S1: NO), and if the controller 17 detects that the D-terminal 21 is hot-plugged (step S3: YES), the controller 17 generates image signals to be output from the D-terminal 21, and outputs these image signals to the television 5 via the D-terminal driver 20 and D-terminal 21 (step S4).

Meanwhile, if the controller 17 detects the HDMI terminal 19 is not hot-plugged (step S1: NO), and also detects the D-terminal 21 is not hot-plugged (step S3: NO), the controller 17 generates image signals to be output from the composite terminal 23, and outputs these image signals to the television 5 via the composite terminal driver 22 and composite terminal 23 (step S5).

Next, the controller 17 determines whether or not the operational mode set by the mode setting unit 16 is play-mode (step S6). If the operational mode is determined to be play-mode (step S6: PLAY), the controller 17 generates sound information for sound output by using sound data recorded by the recorder 25, and outputs the sound information to the television 5 via the HDMI terminal 19 or a sound output terminal (step S7).

On the other hand, if the operational mode is determined to be camera-mode or record-mode in the above-described step S6 (step S6: CAMERA or RECORD), the controller 17 stops the output of sound information via the HDMI terminal 19 or a sound output terminal (step S8).

As described above, in the video camera 1 according to the present embodiment, the output of sound information from the video camera 1 to the television 5 can be stopped when the operational mode is camera-mode or record-mode in which the sound input means of the video camera 1 is in an “ON” status. Consequently, no sound corresponding to the sound information is output from the speaker 51 of the television 5 and re-enters to the sound input means of the video camera 1, so “howling” can be prevented.

Incidentally, the above-described embodiment has been described for the situation where the present invention is applied to the video camera 1 configured as per FIG. 1. However, the present invention is not limited to that embodiment, and may also be broadly applied to image-taking devices having other various configurations.

Also, in the above-described embodiment, the invention has been described for the situation where the HDMI terminal 19, the D-terminal 21 and the composite terminal 23 are provided as external output terminals. However, it should be understood that the external output terminal is not limited to those terminals. For example, the invention can be utilised in the situation where any one terminal of the HDMI terminal 19, the D-terminal 21 and the composite terminal 23 is provided as an external output terminal. Also, for example, the invention can be utilised in the situation where any one of a DVI-D terminal, DV terminal, a component terminal and an S-terminal is provided as an external output terminal.

Furthermore, in the above-described embodiment, the processing steps in the invention have been described for the situation where any one of the HDMI terminal 19, the D-terminal 21, or the composite terminal 23 is hot-plugged, after power is applied to the video camera 1. However, it should be understood that the criterion in detecting a connection to external output terminals is not limited to a “hot-plug.” For example, detecting whether or not a connection cable is already connected to any one of the HDMI terminal 19, the D-terminal 21, or the composite terminal 23 when power is applied to the video camera 1 may be the criterion.

Moreover, in the above-described embodiment, the invention has been described using a television as an external device; however, it should be understood that the external device is not limited to a television. The external device may be, for example, a personal computer, a speaker, or the like.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An image-taking device capable of outputting, to an external device connected via an external output terminal, image information and sound information generated by using an image taken by image-taking means and sound input by sound input means, comprising:
a detecting means for detecting that the external device is connected via the external output terminal,
a mode determining means for determining the operational mode of the image-taking device, and
a sound information output stopping means for stopping sound information output via the external output terminal, when the detecting means detects a connection to the external device and the mode determining means determines that the operational mode is a mode in which sound is input by the sound input means.

2. The image-taking device according to claim 1, wherein:
the external output terminal is an HDMI terminal.
